(19) United States
(12) Patent Application Publication
(10) Pub. No.: US 2010/0149172 A1
(43) Pub. Date: Jun. 17, 2010

(54) SEMICONDUCTOR DEVICE

(75) Inventor: Seiji Tokumasu, Ukyo-Ku (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/635,760

(22) Filed: Dec. 11, 2009

(30) Foreign Application Priority Data
Dec. 11, 2008 (JP) 2008-315717

(51) Int. Cl. G06F 3/038; G06F 1/04

(52) U.S. Cl. 345/214; 327/295

(57) ABSTRACT

A clock distribution circuit receives a clock signal, and distributes the clock signal thus received to multiple paths. A digital circuit is configured as multiple separate regions, each associated with a respective one of the multiple paths. Each region receives a common power supply voltage Vdd. Furthermore, each region operates synchronously with the corresponding clock signal thus distributed by the clock distribution circuit. When the clock signal transmits from the non-input state to the input state, the clock distribution circuit each distributes the clock signal to the multiple paths in a temporally staggered manner.

### BACKGROUND OF THE INVENTION

1. Field of the Invention

The present invention relates to a semiconductor device which operates synchronously with a clock signal.

2. Description of the Related Art

FPDs (Flat Panel Display) such as liquid crystal displays include a circuit referred to as a “timing controller”, which receives image data transmitted from a graphic chip and transmits the image data thus received to a gate driver and a source driver at an appropriate timing.

In recent years, FPDs are known in which, in order to realize reduced power consumption, the transmission frequency for transmission of image data from the graphic chip to the timing controller is switched according to the image properties (such as resolution and the number of colors) of the image to be displayed.

### [Patent Document 1]

Japanese Patent Application Laid Open No. 2006-189996

### [Patent Document 2]

Japanese Patent Application Laid Open No. 2007-323114

The timing controller receives, as an input signal, a clock signal which is used as a reference, in addition to the image data. However, in some cases, before the transmission frequency is switched to the next frequency, the clock signal is temporarily stopped.

In some cases, sudden input of the clock signal after the stopped state leads to sudden operation of the logic circuits (logic gates and memory) in the resting state included in the timing controller. This leads to a sudden current flow in the circuit. The timing controller receives stabilized power supply voltage from a power supply circuit such as an LDO (Low Drop Output), a switching regulator, or the like. However, in a case in which the current suddenly flows through the timing controller, the feedback operation of the power supply circuit cannot keep up with the sudden current flow, leading to a drop in the power supply voltage. In this case, the timing controller cannot operate before the power supply voltage is restored to a predetermined value, leading to malfunction.

Such a problem is not restricted to timing controllers, and can occur in various semiconductor devices.

### SUMMARY OF THE INVENTION

The present invention has been made in order to solve such a problem. It is an exemplary purpose of the present invention to provide a semiconductor device which is capable of solving a problem involved in switching a clock signal.

An embodiment of the present invention relates to a semiconductor device. The semiconductor device includes: a clock distribution circuit which receives a clock signal, and distributes the clock signal thus received to multiple paths; a digital circuit which is configured as multiple regions, each associated with a respective one of the multiple paths. Each region of the digital circuit receives a common power supply voltage. Furthermore, each region of the digital circuit operates synchronously with the corresponding clock signal thus distributed by the clock distribution circuit. With such an embodiment, when the clock signal transits from the non-input state to the input state, the clock distribution circuit each distributes the clock signals to the multiple paths in a temporally staggered manner.

With such an embodiment, the regions of the digital circuit enter the operating state one after the other, thereby increasing the total current that flows through the digital circuit in a stepwise manner. As a result, the power supply circuit can keep up with the change in the current. Thus, such an arrangement reduces the change (drop) in the power supply voltage, thereby operating the digital circuit with greater stability.

Also, a semiconductor device according to the embodiment may further include a clock detection unit which detects whether or not the clock signal has been input. Upon detecting the input of the clock signal by the clock detection unit, the clock distribution circuit may start the distribution of the clock signal to the multiple the paths.

Also, the clock distribution circuit may include: a distribution unit which distributes the clock signal to the multiple paths; multiple gates, provided respectively for the multiple paths; and a gate control unit which controls the ON/OFF operations of the multiple gates. With such an embodiment, upon detecting the input of the clock signal by the clock detection unit, the gate control unit may sequentially switch the multiple gate to the conducting state according to a predetermined sequence.

Also, the semiconductor device may be a timing controller which receives image data and the clock signal from a graphics processor, and which transmits the image data and the clock signal thus received to the gate driver and the source driver.

The timing controller can be suitably applied to a display apparatus having a transmission rate for image data that changes depending on the resolution or the number of colors of the image data. That is to say, such an arrangement is capable of operating the timing controller with high stability even in a case in which the clock signal is temporarily stopped and then is restored when the frequency of the clock signal is switched.

Another embodiment of the present invention relates to a display apparatus. The display apparatus includes: a display panel; a gate driver which drives the scanning lines of the display panel; a source driver which drives the data lines of the display panel; and the above-described timing controller which receives image data and a clock signal, and which transmits the image data and the clock signal thus received to the gate driver and the source driver.

Such an embodiment ensures the stable operation of the timing controller even if the clock signal is temporarily stopped, thereby preventing the abnormal state of the image displayed on the display panel.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram which shows a configuration of a semiconductor device according to an embodiment;

FIG. 2 is a time chart which shows the operation of the semiconductor device shown in FIG. 1; and

FIG. 3 is a block diagram which shows a configuration of an FPD including a timing controller which is a semiconductor device shown in FIG. 1.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

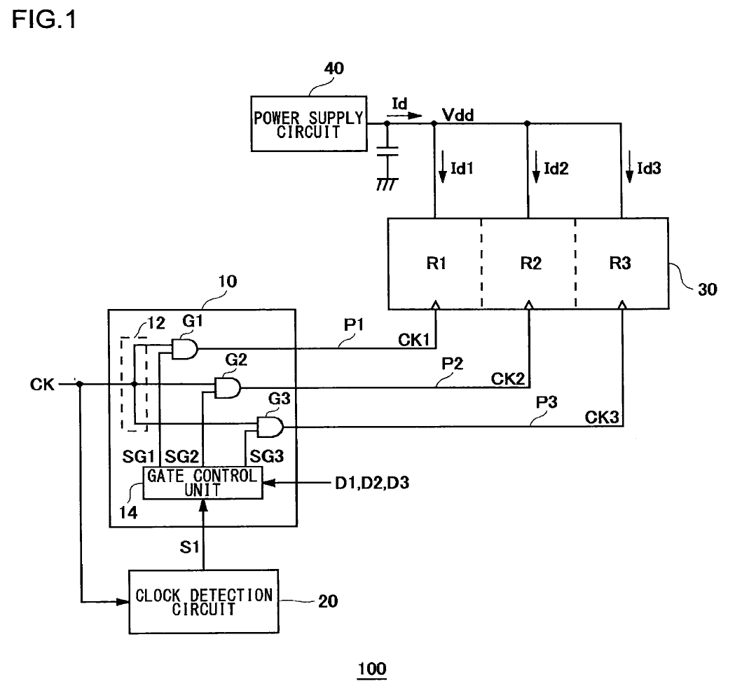

FIG. 1 is a block diagram which shows a configuration of a semiconductor device according to an embodiment. A semiconductor device 100 includes a clock distribution circuit 10, a clock detection circuit 20, a digital circuit 30, and a power supply circuit 40.

The power supply circuit 40 supplies a stabilized power supply voltage Vdd to each block in the semiconductor device 100. The power supply circuit 40 has a configuration including an LDO, a switching regulator, and so forth.

The clock distribution circuit 10 receives a clock signal CK, and distributes this to multiple n (description will be made below regarding an arrangement in which n=3) paths P1 through P3.

The digital circuit 30 has a configuration having multiple separate regions R1 through R3 associated with the multiple paths P1 through P3, respectively. Each of the regions R1 through R3 operates by receiving the common power supply voltage Vdd stabilized by the power supply circuit 40. Furthermore, the regions R1 through R3 execute predetermined signal processing synchronously with the clock signals CK1 through CK3 input via the paths P1 through P3, respectively. The kind of the signal processing is not restricted in particular, and can be determined as desired.

When the clock signal CK transits from a non-input state to an input state, the clock distribution circuit 10 distributes the clock signals CK1 through CK3 to the multiple paths P1 through P3 respectively, in a temporally staggered manner.

The clock detection circuit 20 detects whether or not the external clock signal CK has been input. The clock detection circuit 20 generates a clock detection signal S1 which is asserted when the clock signal CK is input. The clock detection circuit 20 supplies the clock detection signal S1 thus asserted to the clock distribution circuit 10. When the clock detection signal S1 is asserted, i.e., upon detection of the input of the clock signal CK, the clock distribution circuit 10 starts the distribution of the clock signals CK1 through CK3 to the multiple paths P1 through P3.

In order to provide the aforementioned function, the clock distribution circuit 10 may have a configuration including a distribution unit 12, gates G1 through G3, and a gate control unit 14.

The distribution unit 12 distributes the clock signal CK to the multiple paths P1 through P3. The distribution unit 12 may have a tree-type wiring structure. Also, the distribution unit 12 may include multiple buffers connected in a tree structure.

The multiple gates G1 through G3 are provided for the multiple paths P1 through P3, respectively. The ON/OFF operations of the multiple gates G1 through G3 are controlled according to the control signals SG1 through SG3, respectively. For example, each of the gates G1 through G3 may be an AND gate. When the gate control signals SG1 through SG3 are asserted, the gates G1 through G3 are switched to the conducting state (ON state), respectively.

When the clock detection signal S1 is asserted, i.e., when the input of the clock signal CK is detected, the gate control unit 14 sequentially switches the multiple gates G1 through G3 to the ON state in a predetermined sequence order. For example, the gate control unit 14 may receive, as the input data, the data D1 through D3 which indicate the timing at which the gate control signals SG1 through SG3 are asserted. In an example, the data D1 through D3 are data which indicate the time differences τ1 through τ3 from the point in time at which the clock detection signal S1 is asserted up to the points in time at which the clock signals CK1 through CK3 are to be switched to the active state, respectively. The gate control unit 14 may have a configuration including a timer using the CR time constant or a digitally-operating counter circuit. The data D1, D2, and D3 are preferably stored in the memory which can be rewritten as desired. Such an arrangement is capable of optimizing the order and the timing according to which the clock signals CK1, CK2, and CK3 are switched to the active state, based upon the performance of the power supply circuit 40 and so forth. Furthermore, such an arrangement allows the design of the semiconductor device 100 to be modified with great flexibility.

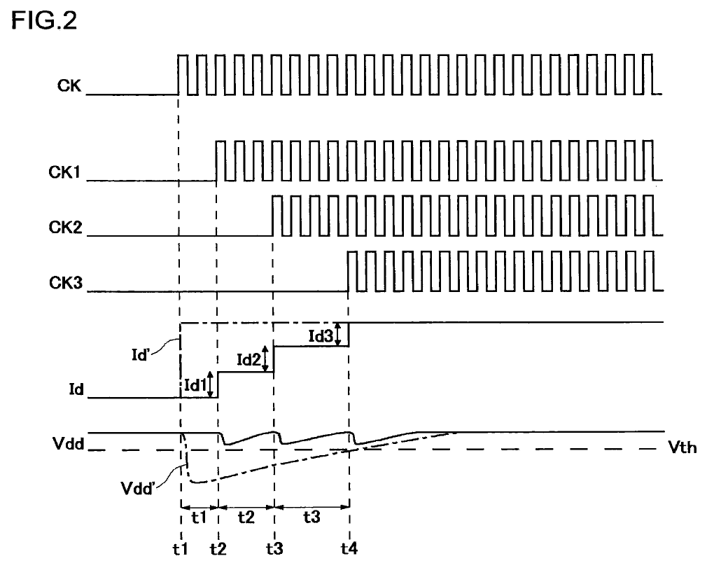

The above is the configuration of the semiconductor device 100. Next, description will be made regarding the operation thereof. FIG. 2 is a time chart which shows the operation of the semiconductor device 100 shown in FIG. 1. It should be noted that the vertical axis and the horizontal axis in the time chart shown in the present specification are expanded or reduced as appropriate for ease of understanding. Furthermore, simple waveforms are shown in the drawing for ease of understanding.

Before the point in time t1, the clock signal CK is in the stopped state (non-input state), and the operations of the regions R1 through R3 of the digital circuit 30 are stationary. When the clock signal CK is input at the point in time t1, the clock detection signal S1 is asserted. Upon reception of the clock detection signal S1 thus asserted, the clock distribution circuit 10 sequentially distributes the clock signals CK1, CK2, and CK3 to the regions R1, R2, and R3, with the predetermined time differences τ1, τ2, and τ3.

When the clock signal CK1 is switched to the active state at the point in time t2, the region R1 starts the operation, and accordingly, the current Id1 flows into the region R1 from the power supply circuit 40. In response to the current Id1, the power supply voltage Vdd supplied from the power supply circuit 40 is slightly reduced, following which the power supply voltage Vdd is restored to the original normal value again due to the feedback effect of the power supply circuit 40. The restoration of the level of the power supply voltage Vdd to the original normal value requires a certain period of time, greater than zero, that depends on the bandwidth of the feedback loop (responsivity) of the power supply circuit 40. The same can be said of the points in time t3 and t4. As a result, the current Id supplied from the power supply circuit 40 to the digital circuit 30 is increased in incremental steps of the currents Id2 and Id3.

The above is the operation of the semiconductor device 100. The advantage of the semiconductor device can be clearly understood by making a comparison with the operation of conventional semiconductor devices. FIG. 2 shows, in the alternate long and short dash lines, the waveforms of the power supply voltage Vdd′ and the power supply current Id′ in the operation of a conventional semiconductor device, i.e., a semiconductor device including no clock distribution circuit 10. In the conventional circuit, the entire region of the digital circuit 30 operates according to the common clock signal CK.

Before the point in time t1, the clock signal CK is in the stopped state (non-input state), and the operations of the regions R1 through R3 of the digital circuit 30 are stationary. When the clock signal CK is input at the point in time t1, the entire region of the digital circuit 30 operates at the same time. In this case, a great current flows into the digital circuit 30 from the power supply circuit 40, leading to a great drop in the power supply voltage Vdd supplied from the power supply circuit 40. Subsequently, the power supply voltage Vdd is restored and stabilized to the original normal value by the feedback operation of the power supply circuit 40. However, such an arrangement requires a long period of time to restore the power supply voltage Vdd to the original normal value due to a great drop in the power supply voltage Vdd. In a case in which the power supply voltage Vdd is smaller than a certain threshold voltage, the digital circuit 30 cannot operate. Accordingly, in a case in which a great drop occurs in the power supply voltage Vdd, in some cases, the digital circuit 30 can malfunction.

On the other hand, referring to the operation of the semiconductor device 100 shown in FIG. 1, the drops in the power supply voltage Vdd (indicated by the solid line), which occur at the points in time t2, t3, and t4, are relatively small as compared with the drop in the power supply voltage Vdd′ (indicated by the alternate long and short dash lines) in conventional arrangements. The reason is that the amount of the drop in the power supply voltage Vdd depends on the current that flows into the digital circuit 30 (more strictly, the change in electric current). The digital circuit 30 shown in FIG. 1 is configured as multiple separate regions R1 through R3. Thus, with such an arrangement, the change in electric current is dramatically reduced as compared with conventional circuits.

As a result, the semiconductor device 100 shown in FIG. 1 operates with reduced drops in the power supply voltage Vdd such that the power supply voltage Vdd is maintained at a voltage level which is not smaller than the threshold voltage, at the points in time t2, t3, and t4 at which the regions R1, R2, and R3 starts the operations thereof, respectively. Alternatively, even if the power supply voltage Vdd is reduced to a value smaller than the threshold voltage, such an arrangement is capable of restoring the power supply voltage Vdd to the normal value in a markedly short period of time, thereby preventing malfunction of the semiconductor device 100. Alternatively, the ineffective period, during which the semiconductor device 100 cannot perform signal processing, is dramatically reduced.

Next, description will be made regarding a suitable application of the semiconductor device 100 shown in FIG. 1. The semiconductor device 100 can be suitably employed as a timing controller for an FPD.

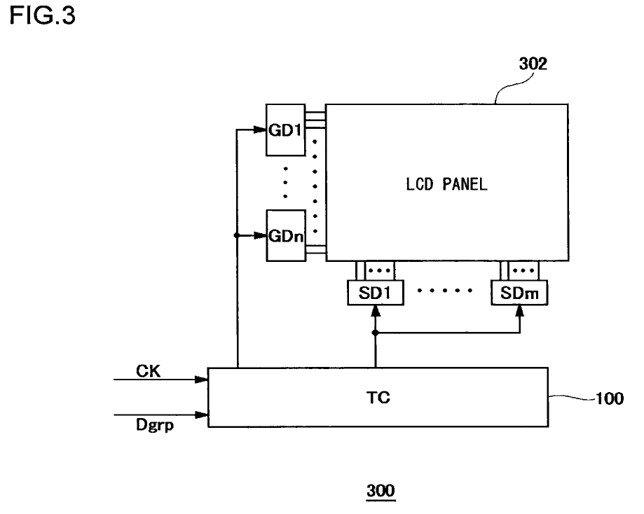

FIG. 3 is a block diagram which shows a configuration of an FPD 300 including the semiconductor device (which will also be referred to as “timing controller TC” hereafter) 100 shown in FIG. 1.

The FPD 300 is a liquid crystal display including an LCD panel 302, multiple gate drivers GD1 through GDn, multiple source drivers SD1 through SDm, and a timing controller TC.

The LCD panel 302 includes multiple data lines, multiple scanning lines, and pixels each provided at the intersections of the data lines and the scanning lines. It should be noted that the panel is not restricted to such an LCD. The panel may be an organic EL panel or a plasma display panel. The multiple gate drivers GD1 through GDn perform the driving operation by sequentially selecting the scanning lines of the LCD panel 302. Furthermore, the source drivers SD1 through SDm perform the driving operation by applying an electric signal (electric current or voltage) that corresponds to the luminance to each of the data lines of the LCD panel 302.

The timing controller TC receives image data Dgrp and a clock signal CK from an unshown graphics processor via a bus. The timing controller TC generates a horizontal synchronization signal and a vertical synchronization signal synchronously with the clock signal CK, transmits luminance data to the source drivers SD1 through SDm according to the image data Dgrp, and instructs the gate drivers GD1 through GDn to select appropriate scanning lines.

With such an arrangement, in some cases, the resolution, the frame rate, the number of colors, etc., can vary depending on the kind of the video image or the like. In this case, the graphics processor changes the transmission rate for the video data Dgrp, and changes the frequency of the clock signal CK. In a case in which a clock signal is generated by an PLL circuit or the like on the graphic processor side, the switching of the frequency requires a certain period of time. Accordingly, when the frequency of the clock signal CK is switched, the clock signal CK is temporarily stopped, following which the clock signal CK is input at the next frequency.

In such a situation, by employing the semiconductor device 100 shown in FIG. 1, such an arrangement prevents malfunction of the FPD 300 when the clock signal CK is temporarily stopped before the next clock signal is input. Thus, the FPD 300 is capable of displaying an image with greater stability.

While the preferred embodiments of the present invention have been described using specific terms, such description is for illustrative purposes only, and it is to be understood that changes and variations may be made without departing from the spirit or scope of the appended claims.

What is claimed is:

1. A semiconductor device comprising:
a clock distribution circuit which receives a clock signal, and distributes the clock signal thus received to a plurality of paths;
a digital circuit which is configured as a plurality of regions, each associated with a respective one of the plurality of paths, and each of which receives a common power supply voltage, and each of which operates synchronously with the corresponding clock signal thus distributed by the clock distribution circuit,
wherein, when the clock signal transits from the non-input state to the input state, the clock distribution circuit each distributes the clock signals to the plurality of paths in a temporally staggered manner.

2. A semiconductor device according to claim 1, further comprising a clock detection unit which detects whether or not the clock signal has been input,
wherein, upon detecting the input of the clock signal by the clock detection unit, the clock distribution circuit starts the distribution of the clock signal to the plurality of the paths.

3. A semiconductor device according to claim 2, wherein the clock distribution circuit comprising:
a distribution unit which distributes the clock signal to the plurality of paths;
a plurality of gates, provided respectively for the plurality of paths; and
a gate control unit which controls the ON/OFF operations of the plurality of gates,
wherein, upon detecting the input of the clock signal by the clock detection unit, the gate control unit sequentially switches the plurality of gate to the conducting state according to a predetermined sequence.

4. A semiconductor device according to claim 1, wherein the semiconductor device comprises a timing controller which receives image data and the clock signal from a graphics processor, and transmits the image data and the clock signal thus received to the gate driver and the source driver.

5. A display apparatus comprising:
a display panel;
a gate driver which drives the scanning lines of the display panel;
a source driver which drives the data lines of the display panel; and
a timing controller which is a semiconductor device according to claim 4, which receives image data and a clock signal, and which transmits the image data and the clock signal thus received to the gate driver and the source driver.
